(19) United States
(12) Patent Application Publication
(10) Pub. No.: US 2025/0252945 A1
(43) Pub. Date: Aug. 7, 2025

(54) METHOD AND APPARATUS FOR CONTROLLING NOISE IN VEHICLE, MEDIUM AND DEVICE

(71) Applicant: XG TECH PTE. LTD., Singapore (SG)

(72) Inventor: Yuxiang HU, Singapore (SG)

(73) Assignee: XG TECH PTE. LTD., Singapore (SG)

(21) Appl. No.: 19/186,703

(22) Filed: Apr. 23, 2025

(30) Foreign Application Priority Data
Jun. 28, 2024 (CN) 202410856170.3

(51) Int. Cl. G10K 11/178

(52) U.S. Cl. CPC G10K 11/17854; G10K 2210/1282

(57) ABSTRACT

Embodiments of the present disclosure disclose a method and apparatus for controlling in-vehicle noise, medium and a device, where the method includes: determining an out-of-vehicle first noise reference signal; the first noise reference signal including a first noise signal acquired by an out-of-vehicle sound sensor; determining, based on the first noise reference signal, a first excitation signal corresponding to an in-vehicle sound player; and controlling, based on the first excitation signal, the in-vehicle sound player to play a noise control sound signal, such that a signal of the noise control sound signal transmitted to the target location in the vehicle at least partially counteracts the noise signal transmitted to the target location from the out-of-vehicle noise.

### CROSS-REFERENCE TO RELATED APPLICATION

The present disclosure claims priority to Chinese Patent Application No. 202410856170.3, filed on Jun. 28, 2024, which is incorporated herein by reference in its entirety.

### FIELD OF THE PRESENT DISCLOSURE

The present disclosure relates to signal processing techniques, and in particular, to a method and apparatus for controlling noise in a vehicle, storage medium and a device.

### BACKGROUND OF THE PRESENT DISCLOSURE

An Acoustic Vehicle Alerting System (AVAS) emits an external audible alert when an electric vehicle is traveling at a low speed, so as to alert pedestrians to ensure safety. If the sound insulation performance of the vehicle is not good enough, a sound pressure level of the AVAS noise transmitted into the vehicle is high, which will cause discomfort of a user in the vehicle and spoil driving experience of a user in the vehicle. In the related art, part of the AVAS noise transmitted into the vehicle is generally reduced by the AVAS active noise reduction method. However, when nonlinearity of an AVAS sound player is strong, a noise reduction effect of the AVAS active noise reduction method is easy to be poor.

### SUMMARY OF THE PRESENT DISCLOSURE

The embodiments of the present disclosure provide a method and apparatus for controlling noise in a vehicle, storage medium, and a device, which can improve a noise reduction effect of the in-vehicle noise, thereby improving driving experience of a user.

In a first aspect of the present disclosure, a method for controlling noise in a vehicle is provided, including: determining a first noise reference signal outside the vehicle, the first noise reference signal at least comprising a first noise signal acquired by an external sound sensor for the vehicle; determining, based on the first noise reference signal, a first excitation signal corresponding to an in-vehicle sound player; and controlling, based on the first excitation signal, the in-vehicle sound player to play a noise control sound signal, such that the noise control sound signal transmitted to a target location in the vehicle at least partially counteracts a noise signal transmitted to the target location from noise outside the vehicle.

In a second aspect of the present disclosure, an apparatus for controlling noise in a vehicle is provided, including: a first processing module configured for determining a first noise reference signal outside the vehicle, the first noise reference signal comprising a first noise signal acquired by an external sound sensor for the vehicle; a second processing module configured for determining, based on the first noise reference signal, a first excitation signal corresponding to an in-vehicle sound player; and a third processing module configured for controlling, based on the first excitation signal, the in-vehicle sound player to play a noise control sound signal, such that the noise control sound signal transmitted to a target location in the vehicle at least partially counteracts a noise signal transmitted to the target location from noise outside the vehicle.

In a third aspect of the present disclosure, a computer-readable storage medium is provided for storing a computer program thereon which, when executed by a processor, cause the processor executing the method for controlling noise in a vehicle according to any of the above-described embodiments of the present disclosure.

In a fourth aspect of the present disclosure, an electronic device is provided, including: a processor; a memory configured to store the processor-executable instructions; wherein the processor is configured to read the executable instructions from the memory and execute the instructions to implement the method for controlling noise in a vehicle according to any of the above-described embodiments of the disclosure.

In a fifth aspect of the present disclosure, a computer program product is provided that, when instructions in the computer program product are executed by a processor, performs the method for controlling in-vehicle noise according to any of the above-described embodiments of the disclosure.

The above-mentioned embodiments of the present disclosure provide a method and apparatus for controlling noise in a vehicle, storage medium and a device, wherein an out-of-vehicle noise signal is acquired by an out-of-vehicle sound sensor as a noise reference signal for determining an excitation signal corresponding to an in-vehicle sound player, and the in-vehicle sound player is controlled to play the noise control sound signal, such that the noise control sound signal transmitted to a target location in the vehicle can at least partially counteract a noise signal transmitted to the target location from noise outside the vehicle, thereby achieving effective control over the in-vehicle noise. Since the actual out-of-vehicle noise signal acquired by the out-of-vehicle sound sensor is taken as the noise reference signal, such that the noise reference signal includes an actual signal of an audible alert played by an out-of-vehicle AVAS, thereby even when the AVAS sound player has a strong non-linearity and the AVAS audible alert is loud, the in-vehicle noise can be effectively controlled, thereby improving the performance of the AVAS noise reduction algorithm, the noise reduction effect, and driving experience of a user. The adverse effects exerted by a certain difference between an acquired ideal reference signal and the actual signal played by the AVAS on the in-vehicle noise reduction caused by the AVAS active noise reduction method of the related art is solved. In addition, the noise signal acquired by the out-of-vehicle sound sensor further includes engine noise, and therefore, it is also possible to control the engine noise transmitted into the vehicle, thereby further improving the noise reduction effect.

### BRIEF DESCRIPTION OF THE DRAWINGS

FIG. 1 is an example application scenario of a method for controlling noise in a vehicle according to the present disclosure;

FIG. 2 is a schematic flow diagram showing a method for controlling noise in a vehicle according to an example embodiment of the present disclosure;

FIG. 3 is a schematic flow diagram showing a method for controlling noise in a vehicle according to another example embodiment of the present disclosure;

FIG. 4 is a schematic flow diagram showing a method for controlling noise in a vehicle according to yet another example embodiment of the present disclosure;

FIG. 5 is a schematic flow diagram showing determination of fixed filter information according to an example embodiment of the present disclosure;

FIG. 6 is a schematic diagram showing an action principle of a first excitation signal according to an example embodiment of the present disclosure;

FIG. 7 is a schematic diagram showing an in-vehicle noise control principle based on an on-line adaptive filter according to an example embodiment of the present disclosure;

FIG. 8 is a schematic diagram showing an optimization principle of a fixed filter according to an example embodiment of the present disclosure;

FIG. 9 is a schematic flow diagram showing a method for controlling noise in a vehicle according to still another example embodiment of the present disclosure;

FIG. 10 is a schematic structural diagram showing a control system for in-vehicle noise according to an example embodiment of the present disclosure;

FIG. 11 is a schematic structural diagram showing an apparatus for controlling noise in a vehicle according to an example embodiment of the present disclosure;

FIG. 12 is a schematic structural diagram showing an apparatus for controlling noise in a vehicle according to another example embodiment of the present disclosure;

FIG. 13 is a schematic configuration diagram showing an apparatus for controlling noise in a vehicle according to yet another example embodiment of the present disclosure;

FIG. 14 is a schematic structural diagram showing an apparatus for controlling noise in a vehicle according to still another example embodiment of the present disclosure;

FIG. 15 is a schematic configuration diagram showing an apparatus for controlling noise in a vehicle according to yet another example embodiment of the present disclosure; and

FIG. 16 is a schematic structural diagram showing an electronic device according to an embodiment of the present disclosure.

### DESCRIPTION OF THE EMBODIMENTS

In order to explain the present disclosure, example embodiments of the present disclosure will be described in detail below referring to the accompanying drawings. It is apparent that the described embodiments are only a part of the embodiments of the present disclosure, not all of them, and it is to be understood that the present disclosure is not limited to the example embodiments.

It should be noted that the relative arrangement of parts and steps, numerical expressions and numerical values set forth in these examples do not limit the scope of the present disclosure unless specifically stated otherwise.

### Overview of the Present Disclosure

In implementing the present disclosure, the inventors have found that an Acoustic Vehicle Alerting System (AVAS) emits an external audible alert when an electric vehicle is traveling at a low speed, so as to alert pedestrians to ensure safety. According to the relevant standards of AVAS, when driving at low speed, for example, below 20 kilometer per hour (km/h), the volume of AVAS is at least 56 decibel (dB), and the maximum volume is up to 75 decibel (dB). If the sound insulation performance of the vehicle is not good enough, a sound pressure level of the AVAS noise transmitted into the vehicle is high, which will cause discomfort of a user in the vehicle and spoil driving experience of a user in the vehicle. In the related art, part of the AVAS noise transmitted into the vehicle is generally reduced by the AVAS active noise reduction method. However, the AVAS active noise reduction method is based on an ideal reference signal to achieve AVAS active noise reduction. When the AVAS sound player has a strong non-linearity, the ideal reference signal and the actual sound played by the AVAS sound player are easy to have a large difference, therefore, it is easy to cause the AVAS active noise reduction method to exert a poor noise reduction effect.

### Example Overview

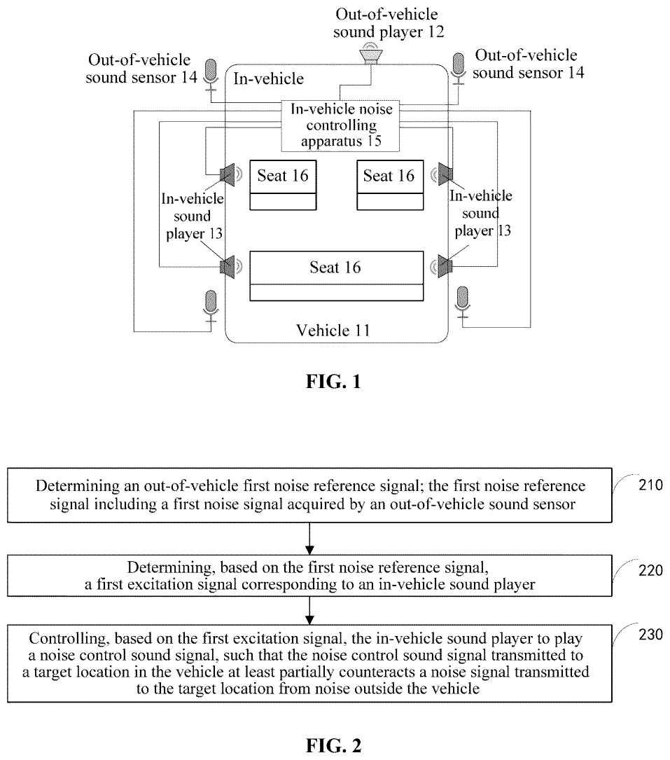

FIG. 1 is an example application scenario of a method for controlling noise in a vehicle according to the present disclosure. As shown in FIG. 1, at least one out-of-vehicle sound player 12 may be provided on a vehicle 11 for playing an audible alert to traffic participants (e.g., pedestrians, riders, etc.) around the vehicle 11, e.g., playback of the audible alert for an AVAS system. At least one in-vehicle sound player 13 (taking 4 in-vehicle sound players in FIG. 1 as an example) may also be provided in the vehicle. The in-vehicle sound player 13 may be used to play relevant sounds to the user in the vehicle, such as playing entertainment programs, audible alerts, etc. to the user in the vehicle. One or more out-of-vehicle sound sensors 14 (taking 4 out-of-vehicle sound sensors in FIG. 1 as an example) may also be provided on the vehicle 11 for acquiring out-of-vehicle sound signals. The out-of-vehicle sound player 12, the in-vehicle sound player 13, and the out-of-vehicle sound sensor 14 are all connected to the apparatus 15 for controlling noise in a vehicle through which the method for controlling noise in a vehicle in the present disclosure is implemented. The in-vehicle sound player 13 can be used as a secondary sound source for counteracting the noise transmitted into vehicle from the out-of-vehicle noise source, so as to control a sound pressure level of the in-vehicle noise and improve driving comfort of a user in the vehicle. The out-of-vehicle noise source includes, but is not limited to, an audible alert played by the out-of-vehicle sound player 12, a noise generated by an engine of the vehicle 11 (abbreviated as engine noise), etc. Specifically, the purpose of reducing the sound pressure level of the in-vehicle noise may be achieved by performing the following: determining a first noise reference signal outside the vehicle, the first noise reference signal comprising a noise signal (referred to as a first noise signal) acquired by an external sound sensor for the vehicle; determining, based on the first noise reference signal, a first excitation signal corresponding to an in-vehicle sound player 13; and controlling, based on the first excitation signal, the in-vehicle sound player 13 to play a noise control sound signal, such that the noise control sound signal transmitted to a target location in the vehicle at least partially counteracts a noise signal transmitted to the target location from noise outside the vehicle. The target location may be set according to actual noise reduction requirements, for example, the target location may be set to a location where the top end of the back of a user's seat 16 is near the user's ear. Therefore, the sound pressure level of the noise signal at the target location in the vehicle can be reduced, the external noise transmitted into the vehicle can be effectively controlled, and driving comfort of a user in the vehicle can be improved. In the present disclosure, due to the actual out-of-vehicle noise signal acquired by the out-of-vehicle sound sensor 14 as a noise reference signal, which can include the actual signal of the audible alert played by the out-of-vehicle sound player 12, even in a case where the out-of-vehicle sound player 12 has a strong non-linearity and the audible alert played by the out-of-vehicle sound player 12 is relatively loud, the in-vehicle noise can be effectively controlled, thereby improving the performance of the AVAS noise reduction algorithm, the noise reduction effect, and driving experience of a user. The adverse effects exerted by a certain difference between an acquired ideal reference signal and the actual signal played by the AVAS on the in-vehicle noise reduction caused by the AVAS active noise reduction method of the related art can be solved. In addition, the noise signal acquired by the out-of-vehicle sound sensor 14 further includes engine noise, and therefore, it is also possible to control the engine noise transmitted into the vehicle, thereby further improving the noise reduction effect. In addition, in a case of a vehicle equipped with an out-of-vehicle sound sensor, the out-of-vehicle sound sensor of the vehicle can be reused, such that the sound pressure level of the in-vehicle noise can be reduced without increasing hardware costs.

### Examples of Method

FIG. 2 is a schematic flow diagram showing a method for controlling noise in a vehicle according to an example embodiment of the present disclosure. This embodiment can be applied to an electronic device, specifically such as a vehicle-mounted computing platform or a signal processing device, and as shown in FIG. 2, the method of the embodiment of the present disclosure can include the following steps:

Step 210, determining a first noise reference signal outside the vehicle, the first noise reference signal comprising a first noise signal acquired by an external sound sensor for the vehicle.

The out-of-vehicle noise source (or referred to as an out-of-vehicle sound source) corresponding to the first noise reference signal may include one or more sound sources. For example, the out-of-vehicle noise source may include at least one of an out-of-vehicle sound player, a vehicle engine, and any other possible out-of-vehicle sound source. Sound generated by the out-of-vehicle noise source (referred to as out-of-vehicle noise) is transmitted into the vehicle to form noise in a vehicle (referred to as in-vehicle noise). The out-of-vehicle sound player is a sound player provided on a vehicle for interacting with out-of-vehicle traffic participants, for example, the out-of-vehicle sound player may be used for playing an audible alert of an AVAS system, or for playing an associated sound for other functions. The first noise reference signal includes at least a noise signal (i.e., a first noise signal) acquired by the out-of-vehicle sound sensor for controlling noise transmitted out of the vehicle (or from an out-of-vehicle noise source) into the vehicle. The out-of-vehicle sound sensor is a sensor that can acquire sound signals, for example, the out-of-vehicle sound sensor can be a microphone that acquires external sound.

In some alternative embodiments, the number of the out-of-vehicle sound sensors may be one or more. As shown in FIG. 1, the number of the out-of-vehicle sound sensors is 4.

In some alternative embodiments, the first noise reference signal may further include other signals that may act as noise reference signals. For example, the first noise reference signal may further include a second noise signal generated by an engine, an excitation signal for controlling the out-of-vehicle sound player to play a sound signal, etc.

Step 220, determining, based on the first noise reference signal, a first excitation signal corresponding to an in-vehicle sound player.

The first excitation signal is an electrical signal for controlling the in-vehicle sound player to play the sound signal. The in-vehicle sound player may be a sound player provided at a predetermined location in the vehicle for interacting with a user in the vehicle. The preset location may be set according to actual requirements, to which the embodiments of the present disclosure are not limited.

In some alternative embodiments, the first noise reference signal may be converted to a corresponding first excitation signal of the in-vehicle sound player according to a predetermined signal conversion mode (or control information for signal conversion).

In some alternative embodiments, the signal conversion mode may be determined in real time, and the first noise reference signal is converted into the first excitation signal corresponding to the in-vehicle sound player according to the obtained signal conversion mode.

In some alternative embodiments, the signal conversion mode functions to control the sound signal played by the in-vehicle sound player via the first excitation signal to at least partially counteract the out-of-vehicle noise (or referred to as an out-of-vehicle sound) that is transmitted to a designated location (i.e., a target location) in the vehicle for the purpose of reducing the sound pressure level of the in-vehicle noise. The signal conversion mode may be obtained based on the error sound signal at the target position between the out-of-vehicle noise and the sound signal played by the in-vehicle sound player. For example, the out-of-vehicle noise source can be controlled to determine a test noise reference signal in advance in the test scene, and the signal conversion mode can be continuously optimized based on the initialized signal conversion mode according to the acquired error sound signal at the target location until the error sound signal converges to a smaller error threshold, and the optimized signal conversion mode can be obtained as a fixed signal conversion mode and stored. Then, in the actual traveling process of the vehicle, the first noise reference signal acquired in real time can be converted according to the prestored signal conversion mode to obtain the first excitation signal. Alternatively, the signal conversion mode at the previous time may be updated and optimized as the signal conversion mode at the next time based on the error sound signal acquired in real time at each time during the traveling of the vehicle. That is, at the current time, the first noise reference signal at the current time is converted based on the signal conversion mode updated in real time at the previous time, so as to obtain the first excitation signal. In addition, the error sound signal at the current time can be continuously acquired, the signal conversion mode updated at the previous time is updated, and the updated signal conversion mode at the current time is obtained as the signal conversion mode at the next time, and so on, which will not be described in detail.

Step 230, controlling, based on the first excitation signal, the in-vehicle sound player to play a noise control sound signal, such that the noise control sound signal transmitted to a target location in the vehicle at least partially counteracts a noise signal transmitted to the target location from noise outside the vehicle.

The first excitation signal may be transmitted to the in-vehicle sound player, and the in-vehicle sound player may convert the first excitation signal into a sound signal and play, and the working principle of the in-vehicle sound player is not described in detail. In this case, the in-vehicle sound player functions as a secondary sound source, the played sound signal is a noise control sound signal, and the noise control sound signal transmitted to the target location in the vehicle is phase-inverted relative to a noise signal of the out-of-vehicle noise transmitted to the target location so as to totally counteract or at least partially counteract the noise signal of the out-of-vehicle noise transmitted to the target location. The degree to which the noise signal can be counteracted can be controlled by the degree of optimization of the signal conversion mode. The smaller the error sound signal in the optimization process, the larger the proportion of the noise signal that can be counteracted, such that the smaller the noise that can be heard by the user in the vehicle, and therefore the better the in-vehicle noise reduction effect. The target location may be set according to in-vehicle noise control requirements. This may be provided, for example, depending on where a user's head or ears are likely to be located within the vehicle.

In some alternative embodiments, the in-vehicle sound player may be connected to an apparatus of the present disclosure in any implementation to transmit a signal. Connections may include, for example, wired, wireless connections, etc.

In some alternative embodiments, the target location may include one or more locations. For example, the target location may include a location within the vehicle at which the user's head or ears corresponding to at least one seat may be located. For example, the seat top location of a driving seat, a passenger seat, and each seat in a rear row, which is not specifically limited.

According to the method for controlling noise in a vehicle provided in this embodiment, since the actual out-of-vehicle noise signal acquired by the out-of-vehicle sound sensor is taken as the noise reference signal, such that the noise reference signal includes an actual signal of an audible alert played by an out-of-vehicle AVAS, even when the AVAS sound player has a strong non-linearity and the AVAS audible alert is loud, the in-vehicle noise can be effectively controlled, thereby improving the performance of the AVAS noise reduction algorithm, the noise reduction effect, and t driving experience of a user. The adverse effects exerted by a certain difference between an acquired ideal reference signal and the actual signal played by the AVAS on the in-vehicle noise reduction caused by the AVAS active noise reduction method of the related art is solved. In addition, the noise signal acquired by the out-of-vehicle sound sensor further includes engine noise, and therefore, it is also possible to control the engine noise transmitted into the vehicle, thereby further improving the noise reduction effect.

In some alternative embodiments, the first noise reference signal may further include at least one of:

a second excitation signal for controlling an out-of-vehicle sound player to play a sound signal and a second noise signal generated by an engine.

The second excitation signal is an electrical signal used for generating a corresponding sound signal, and the out-of-vehicle sound player can convert the second excitation signal into the corresponding sound signal for playing, for example, playing the audible alert, interacting with out-of-vehicle traffic participants, so as to alert pedestrians to ensure safety. The second noise signal generated by an engine (motor) can be obtained from engine speed information acquired by a vehicle bus. The second noise signal may include a harmonic noise signal generated by the engine. For example, it may include noise signals from the 1^{st} harmonic to the K^{th} harmonic. K is a positive integer.

In some alternative embodiments, the second excitation signal may be obtained from a component or device that generates the second excitation signal. For example, in the AVAS, the second excitation signal may be generated by a signal processing device, such as a signal processing chip, and the second excitation signal may be acquired from the signal processing device. It is also possible to preset, such that after the second excitation signal is generated by the corresponding device, the second excitation signal is transmitted to the apparatus of the present disclosure for use in the process flow of the method for controlling noise in the vehicle of the present disclosure. It is also possible that the apparatus of the present disclosure itself can be used for generating the second excitation signal, and the generated second excitation signal is used for the out-of-vehicle sound player as well as the process flow of the method for controlling the noise in the vehicle of the embodiments of the present disclosure. The specific manner in which the second excitation signal is acquired is not limited.

In some alternative embodiments, the first noise reference signal at time n may include a first noise signal [x_{mic}¹(n), x_{mic}²(n), . . . , x_{mic}^{M}(n)] acquired by one or more out-of-vehicle sound sensors, the second excitation signal xₐᵥₐₛ(n) corresponding to the out-of-vehicle sound player, and a second noise signal [x_{enc}¹(n), x_{enc}²(n), . . . , x_{enc}^{K}(n)] of 1^{st} harmonic to the K^{th} (K≥1) harmonic generated by an engine, i.e., the first noise reference signal at time n may be represented as x(n)=[x_{mic}¹(n), x_{mic}²(n), . . . , x_{mic}^{M}(n), xₐᵥₐₛ(n), x_{enc}¹(n), x_{enc}²(n), . . . , x_{enc}^{K}(n)]^{T}. mic represents the out-of-vehicle sound sensor, M represents a number of the out-of-vehicle sound sensors, M≥1, and avas represents the out-of-vehicle sound player, and enc represents engine noise. It can be seen that, based on the first noise signal, an increase in the type of the noise reference signal results in an increase in dimension of the first noise reference signal, and the corresponding signal conversion mode is adapted to change, and the specific operation principles of steps 210 to 230 are consistent with the above-mentioned embodiments. For example, in a case of signal conversion by a filter, the dimension of the first noise reference signal increases and the dimension of the filter coefficients increases accordingly. The detailed control process will not be described in detail.

In some alternative embodiments, an engine speed is expressed as R revolutions per minute, then a fundamental frequency of the engine harmonic noise is f₁=R/60 Hz, then the (j (j=1, 2, . . . , K)^{th} harmonic noise signal x_{enc}^{j}(n) generated by the engine at time n may be expressed as:

$${x}_{e n c}^{j} ( n ) = sin \frac{2 π j {f}_{1}}{{f}_{s}} n$$

fₛ represents an audio sampling frequency.

In this embodiment, at least one of the second excitation signal corresponding to the out-of-vehicle sound player and the second noise signal generated by the engine is used together with the first noise signal as a first noise reference signal for controlling the in-vehicle noise, and since the second excitation signal is the excitation signal of the sound signal of the AVAS, the second excitation signal is used for the noise reference signal, more effective noise control can be performed on the sound signal played by the AVAS, such that the algorithm performance of the AVAS noise reduction can be further improved. Using the second noise signal generated by the engine as a noise reference signal allows for more effective control over engine noise. Additionally, the first noise signal acquired by the out-of-vehicle sound sensor may include noise other than harmonics generated by the engine (e.g., broadband noise), and using the first noise signal in combination with the second noise signal, the performance of the engine noise control algorithm can be significantly improved, addressing the limitation of existing Engine Noise Control (ENC) algorithms, which can only control harmonic signals and fail to manage broadband noise.

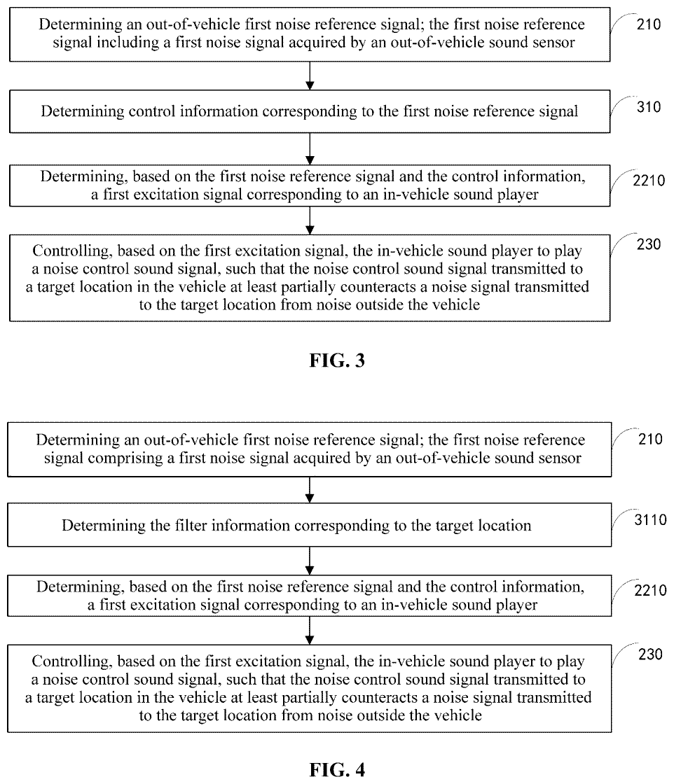

FIG. 3 is a schematic flow diagram showing a method for controlling noise in the vehicle according to another example embodiment of the present disclosure.

In some alternative embodiments, based on any one of the embodiments described above, as shown in FIG. 3, the method in the embodiment of the present disclosure may further include:
step 310, determining control information corresponding to the first noise reference signal.

The control information (i.e., the signal conversion mode described above) may be obtained in advance and stored in a preset storage area, such as any storage area on the vehicle that can be accessed directly or indirectly by the apparatus of the present disclosure. Alternatively, the control information may be obtained on-line in real time. See the foregoing in details.

In some alternative embodiments, the control information may be the filter coefficients of the filter, for example, may be the filter coefficients of the fixed filter obtained through preoptimization, or may be the filter coefficients of an adaptive filter updated online in real time, which is not specifically limited.

The step 220 of the determining, based on the first noise reference signal, a first excitation signal corresponding to an in-vehicle sound player may include:

step 2210, determining, based on the first noise reference signal and the control information, the first excitation signal corresponding to the in-vehicle sound player.

After the control information is determined, the first noise reference signal can be converted into the first excitation signal corresponding to the in-vehicle sound player via the control information, such that a sound signal generated by the first excitation signal which is transmitted to the target location can at least partially counteract the noise signal transmitted to the target location by the out-of-vehicle noise, so as to reduce a sound pressure level of the noise at the target location.

This embodiment achieves effective conversion of the first noise reference signal to the first excitation signal corresponding to the in-vehicle sound player through the control information corresponding to the first noise reference signal, thereby achieving effective control over the in-vehicle noise, without reducing the sound pressure level of the sound played by the out-of-vehicle sound player, so as to ensure effective interaction with the out-of-vehicle traffic participants. In addition, there is no need to improve the vehicle hardware to improve the sound insulation performance, which helps to control costs.

FIG. 4 is a schematic flow diagram showing a method for controlling noise in a vehicle according to yet another example embodiment of the present disclosure.

In some alternative embodiments, as shown in FIG. 4, the step 310 of determining control information corresponding to the first noise reference signal in a case that the control information may include filter information may include:
step 3110, determining the filter information corresponding to the target location.

The filter information may include the number of filters and the filter coefficient(s) for each filter. The filter information may be different for different target locations. Therefore, for different target locations in the vehicle, filter information corresponding to the target location can be acquired as control information for performing filtering processing on the first noise reference signal to obtain the first excitation signal. For example, if the target location includes one location within the vehicle, the target filter coefficient corresponding to the target location of the driving seat may be different from the filter information corresponding to the target location of the passenger seat. If the target location includes a plurality of locations, the filter information corresponding to different combination of locations may also be different. For example, the target locations include two locations, a target location for a driving seat and a target location for a passenger seat, and the filter information for the two locations may be different from that for the driving seat and a rear row. The filter information may be prestored or may be obtained in real time, or updated at a previous time. That is, the filter information used at the previous time is updated according to an error sound signal acquired at the previous time, and the updated filter information is obtained as the filter information corresponding to the target location at the current time.

In some alternative embodiments, the target location may be determined based on the actual case of the user in the vehicle. The target location may be determined, for example, based on the location information of the user in the vehicle. The location information of the user in the vehicle may be obtained in any implementation. For example, the location information of the user is obtained based on image recognition, the location information of the user is obtained based on sound source localization, or the location information of the user is obtained based on seat sensors, etc.

In some alternative embodiments, the corresponding filter information may be determined and stored separately for each case where a different number of users are driving in the vehicle. For example, in a case where only the driver is present, the filter information corresponding to the target location corresponding to the driver is obtained and stored. For various cases of a user having a driver and at least one other seat in the vehicle, such as a driver and a passenger user, the driver and one user in the rear row, the driver and the passenger user and two users in the rear row, etc., filter information respectively corresponding to the various cases is obtained and stored. Each case can be identified as a type, and then during the traveling of the vehicle, a specific type of the target location of the user in the vehicle can be determined according to the actually detected user location information, and the filter information corresponding to the type can be acquired for the control over the in-vehicle noise.

In some alternative embodiments, corresponding control information may also be determined in real time on-line for various cases where different numbers of users are driving in the vehicle to provide noise control at the target locations corresponding to the users in the vehicle.

In this embodiment, the filter information corresponding to the target location is used as the control information for converting the first noise reference signal to obtain the first excitation signal, such that the noise control at the target location can be effectively realized, and the targeted noise control for different target locations in the vehicle can be facilitated, the noise reduction effect can be further improved, and the user experience can be further improved.

In some alternative embodiments, the first noise reference signal is a noise reference signal at a current time.

the step 3110 of determining the filter information corresponding to the target location may include: determining the filter information corresponding to the target location at the current time based on a historical noise reference signal at a historical time prior to the current time, historical filter information at a previous time corresponding to the target location, and a historical error sound signal acquired by a sound sensor at the target location at the previous time.

The number of the historical time may be one or more. The previous time refers to a previous historical time (i.e., time n−1) of the current time (time n). The historical filter information for the previous time (which may be simply referred to as previous filter information) is the filter information used by the noise control process for the previous time. That is, at the previous time, the first excitation signal at the previous time is obtained based on the historical filter information and the historical noise reference signal at the previous time, so as to realize the in-vehicle noise control at the previous time. The historical filter information for the previous time (time n−1) may be obtained by updating the historical filter information at time n−2 based on an error sound signal acquired at time n−2. For example, when the current time is time n, the filter information used by the noise control process at time n−1 may be obtained by updating the filter information at time n−2 based on the error sound signal at time n−2. The error sound signal of the previous time may also be acquired and recorded at the previous time as a historical error sound signal of the current time for real time updating of the filter information.

In some alternative embodiments, the filter information at the previous time can be directly updated after the error sound signal is acquired at the previous time to obtain the updated filter information, and then the updated filter information at the previous time can be directly obtained at the current time as the filter information corresponding to the target location at the current time, such that the processing efficiency of the noise control process at the current time can be further improved.

In this embodiment, since the historical error sound signal of the previous time represents the error of the sound signal of the first excitation signal obtained by the filter information of the previous time and the historical noise reference signal of the previous time at the target location, and the previous filter information is updated by means of the historical error sound signal, the error at the target location can be further reduced, that is, the residual noise signal after being counteracted at the target location can be reduced, while the error sound signal at the previous time has a stronger timeliness with respect to the current time, and therefore the noise reduction effect at the target location can be further improved at the current time.

In some alternative embodiments, the determining the filter information corresponding to the target location at the current time based on a historical noise reference signal at a historical time prior to the current time, historical filter information at a previous time corresponding to the target location, and a historical error sound signal acquired by a sound sensor at the target location at the previous time may include:
determining a historical filtered reference signal based on the historical noise reference signal, a secondary path transfer function between the in-vehicle sound player and the target location; and updating, based on the historical filtered reference signal and the historical error sound signal, the historical filter information to obtain the filter information corresponding to the target location at the current time.

The secondary path transfer function is obtained by modeling an actual secondary path between the in-vehicle sound player and the target location for estimating the sound transmission of the secondary path. The historical filtered reference signal is the filtered reference signal of the historical noise reference signal transformed by the secondary path transfer function for the optimal update of the filter information.

In some alternative embodiments, the historical filter information may be updated based on filter information update rules to obtain filter information corresponding to the target location at the current time.

In some alternative embodiments, the error sound signal at the target location may be acquired by an in-vehicle sound sensor (which may be referred to as an error sound sensor or an error sensor) provided at the target location. The number of error sound sensors may be one or more.

Illustratively, taking the first noise reference signal including a first noise signal, a second excitation signal and a second noise signal as an example, the number of out-of-vehicle sound sensors being M, the number of out-of-vehicle sound players being 1, and the second noise signal including a signal from the 1^{st} harmonic to the K^{th} harmonic generated by the engine, and taking an in-vehicle error sound sensor and the number of secondary sources (i.e., in-vehicle sound players) both being 1 as an example, the historical filtered reference signal v(n−1) can be expressed as follows:

$$v ( n - 1 ) = {X}_{s}^{T} ( n - 1 ) \hat{S}$$

$${X}_{s} ( n - 1 ) = {[ \begin{matrix}x ( n - 1 ) & x ( n - 2 ) & … & x ( n - {L}_{s} )\end{matrix} ]}^{T}$$

$$x ( n - i ) = {[ {x}_{m i c}^{1} ( n - i ) , {x}_{m i c}^{2} ( n - i ) , … , {x}_{m i c}^{M} ( n - i ) , \\ {x}_{a v a s} ( n - i ) , {x}_{e n c}^{1} ( n - i ) , {x}_{e n c}^{2} ( n - i ) , … , {x}_{e n c}^{K} ( n - i ) ]}^{T}$$

T represents transpose, Xₛ^{T}(n−1) represents historical noise reference information with dimension of L=(M+1+K)*Lₛ, i.e., Xₛ^{T}(n−1) may represent a matrix with a row (M+1+K) and a column Lₛ, and Ŝ=[ŝ₁ ŝ₂ . . . ŝ_{L}_{ₛ}]^{T} represents an estimated secondary path, i=1, 2, . . . , Lₛ. x(n−i) represents a historical noise reference signal at time n−i. Reference can be made to the forgoing for the meanings of the other symbols.

The historical filter information W(n−1) at the previous time may be expressed as follows:

$$W ( n - 1 ) = {[ \begin{matrix}{w}_{1} ( n - 1 ) & {w}_{2} ( n - 1 ) & … & {W}_{{L}_{w}} ( n - 1 )\end{matrix} ]}^{T}$$

where wᵢ(n−1) is filter information (i=1, . . . , L_{w}) corresponding to v(n−i), and the dimension of wᵢ(n−1) is (M+1+K)*1, that is to say, wᵢ(n−1) includes M+1+K filter coefficients, then the filter information corresponding to the target location at the current time can be obtained by the following update rule:

$$W ( n ) = W ( n - 1 ) - μ V ( n - 1 ) e ( n - 1 )$$

$$V ( n - 1 ) = [ \begin{matrix}v ( n - 1 ) & v ( n - 2 ) & … & v ( n - {L}_{w} )\end{matrix} ]$$

where μ represents an iteration step size, v(n−i) represents a historical filtered reference signal at time n−i (i=1, . . . , L_{w}), v(n−i) is obtained at time n−i on the basis of a historical noise reference signal x(n−i) at time n−i and a secondary path transfer function, and the dimension of v(n−i) is (M+1+K)*1. That is, in updating the filter information, in addition to the historical filtered reference signal at the previous time, the previous filter information may be updated in conjunction with one or more historical filtered reference signals preceding the historical filtered reference signal at the previous time (which may have been obtained and stored at the previous time). The number of the historical filtered reference signals specifically employed is consistent with dimension of the filter information, i.e., (M+1+K)*L_{w}.

Based on the above-described example, in a case where the number of at least one of the error sound sensor and the in-vehicle sound player is greater than 1, control over the in-vehicle noise can be achieved by increasing the dimension of the filter information accordingly. For example, if the number of in-vehicle sound players is J, the dimension of the filter information is expanded to J*(M+1+K)*L_{w}.

Illustratively, if the number of the in-vehicle sound players is J, and the number of the error sound sensors is D, the historical filtered reference signal may be expressed as follows:

$${v}_{j d} ( n - 1 ) = {X}_{s}^{T} ( n - 1 ) {\hat{S}}_{j d}$$

$${X}_{s} ( n - 1 ) = {[ \begin{matrix}x ( n - 1 ) & x ( n - 2 ) & … & x ( n - {L}_{s} )\end{matrix} ]}^{T}$$

$$x ( n - i ) = {[ {x}_{m i c}^{1} ( n - i ) , {x}_{m i c}^{2} ( n - i ) , … , {x}_{m i c}^{M} ( n - i ) , \\ {x}_{a v a s} ( n - i ) , {x}_{e n c}^{1} ( n - i ) , {x}_{e n c}^{2} ( n - i ) , … , {x}_{e n c}^{K} ( n - i ) ]}^{T}$$

$${\hat{S}}_{jd} = {[ \begin{matrix}{\hat{s}}_{1 jd} & {\hat{s}}_{2 jd} & … & {\hat{s}}_{( {L}_{s} - 1 ) jd}\end{matrix} ]}^{T}$$

the historical filter information for the previous time may include J filter information as follows:

$${W}_{j} ( n - 1 ) = {[ \begin{matrix}{w}_{1 j} ( n - 1 ) & {w}_{2 j} ( n - 1 ) & … & {w}_{( {L}_{w} ) j} ( n - 1 )\end{matrix} ]}^{T}$$

$${W}_{j} ( n ) = {W}_{j} ( n - 1 ) - μ {\sum }_{d = 1}^{D} {V}_{j d} ( n - 1 ) {e}_{a} ( n - 1 )$$

$${V}_{j d} ( n - 1 ) = [ \begin{matrix}{v}_{j d} ( n - 1 ) & {v}_{j d} ( n - 2 ) & … & {v}_{j d} ( n - {L}_{w} )\end{matrix} ]$$

where Ŝ_{jd} represents a secondary path between the estimated (j (j=1, 2, J))^{th} in-vehicle sound player and the d(d=1, 2, D)^{th} error sound sensor, and Wⱼ(n−1) represents the j^{th} filter information at time n−1. v_{jd}(n−1) represents the historical filtered reference signal obtained by Ŝ_{jd} transformation. e_{d}(n−1) represents an error sound signal acquired by a d^{th} error sound sensor at time n−1. Reference can be made to the forgoing for additional symbols.

In this embodiment, by effectively estimating the sound transmission of the secondary path through the secondary path transfer function between the in-vehicle sound player and the target location, the signal in the historical noise reference signal transmitted to the target location can be estimated, and in combination with the historical error sound signal at the target location, the excitation signal that the in-vehicle sound player should have can be estimated, such that the estimated excitation signal can guide the update of the filter information to realize the optimization of the filter, and provide more accurate and effective filter information for the noise control at the current time.

In some alternative embodiments, the step 3110 of determining the filter information corresponding to the target location may include: acquiring fixed filter information corresponding to the target location obtained in advance. The fixed filter information can be understood as preconfigured filter information, rather than filter information that changes in real time on-line.

The fixed filter information can be obtained by optimizing initialized filter information based on historical noise reference signals and historical error sound signals acquired in advance at a plurality of times. The fixed filter information is used as control information for in-vehicle noise control.

In this embodiment, with the fixed filter information served as the control information, calculated amount of signal processing may be reduced and the efficiency of signal processing may be improved.

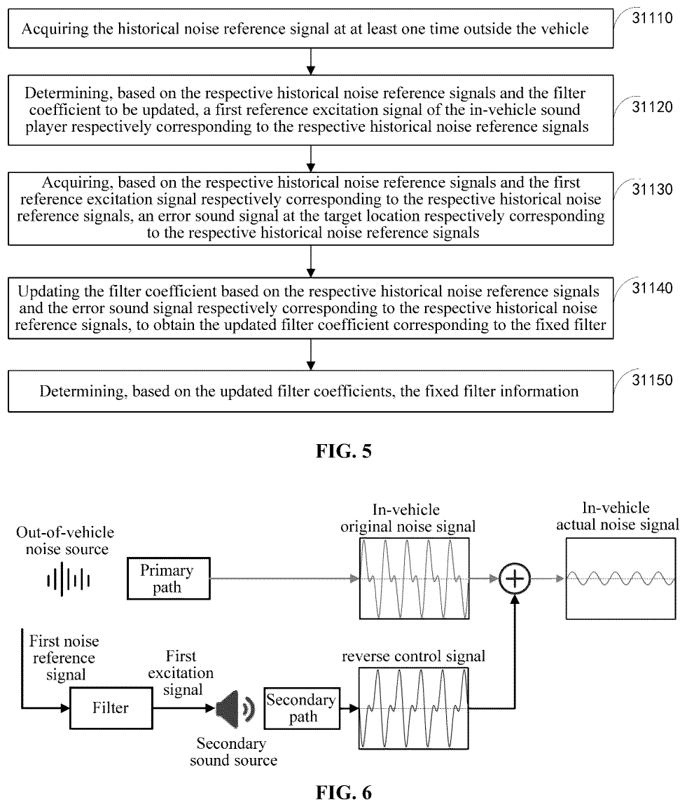

FIG. 5 is a schematic flow diagram showing determination of fixed filter information according to an example embodiment of the present disclosure.

In some alternative embodiments, the fixed filter information includes the filter coefficient(s) of the fixed filter. As shown in FIG. 5, the fixed filter information can be obtained by the following steps:
step 31110, acquiring the historical noise reference signal at at least one time outside the vehicle.

The at least one time may include one or more historical times. The historical noise reference signal at any one time may be a noise reference signal determined at that time in a manner similar to that described above for the first noise reference signal, and will not be described in detail herein.

Step 31120, determining, based on the respective historical noise reference signals and the filter coefficient to be updated, a first reference excitation signal of the in-vehicle sound player respectively corresponding to the respective historical noise reference signals.

The filter coefficient(s) to be updated may be initialized filter coefficient(s), or filter coefficient(s) obtained from a certain number of iterations, which is not specifically limited. Each historical noise reference signal is converted based on the filter coefficients to be updated to obtain a first reference excitation signal of the in-vehicle sound player respectively corresponding to each historical noise reference signal.

In some alternative embodiments, for each time, the historical noise reference signal for that time and the historical noise reference signal for one or more times prior to that time may be filtered based on the filter coefficients to be updated to obtain the first reference excitation signal for that time.

Step 31130, acquiring, based on the respective historical noise reference signals and the first reference excitation signal respectively corresponding to the respective historical noise reference signals, an error sound signal at the target location respectively corresponding to the respective historical noise reference signals.

For each time, a sound signal corresponding to the first reference excitation signal can be played by an in-vehicle sound player at that time, such that the sound signal can be superimposed with a noise signal from a corresponding out-of-vehicle noise source at a target location, and an error sound signal at the target location is acquired by a sound sensor (which may be referred to as an error sound sensor) at the target location to obtain a historical error sound signal at that time.

In some alternative embodiments, the acquisition of historical noise reference signals and the acquisition of error sound signals at a plurality of times may be accomplished by controlling the noise generated by the out-of-vehicle noise source over a period of time. For example, the noise generated by the engine is controlled by controlling the engine speed information, the noise generated by the out-of-vehicle sound player is controlled by preconfiguring the excitation signal of the out-of-vehicle sound player, etc.

Step 31140, updating the filter coefficient to be updated based on the respective historical noise reference signals and the error sound signal respectively corresponding to the respective historical noise reference signals, to obtain the updated filter coefficient corresponding to the fixed filter.

The filter coefficients to-be-updated can be updated based on a pre-obtained filter coefficient update rule to obtain updated filter coefficients.

Step 31150, determining, based on the updated filter coefficient, the fixed filter information.

If the updated filter coefficient satisfies an update end condition, the updated filter coefficient may be used as the fixed filter information. If the updated filter coefficient does not satisfy the update end condition, the updated filter coefficient may be used as the filter coefficients to be updated, and the above-mentioned steps 31110 to 31150 may be repeated until the updated filter coefficient satisfy the update end condition. The update end condition may be an expected minimization condition of the error sound signal. For example, the expectation of the error sound signal is less than a threshold.

In this embodiment, the filter coefficient of the fixed filter obtained by off-line optimization in advance is stored as the fixed filter information. In the real time application process of the vehicle, the filter coefficient of the fixed filter can be directly acquired for the control over the in-vehicle noise, and the calculation of the on-line adaptive update filter can be reduced, thereby improving the efficiency of signal processing.

In some alternative embodiments, the step 31130 of acquiring, based on the respective historical noise reference signals and the first reference excitation signal respectively corresponding to the respective historical noise reference signals, an error sound signal at the target location respectively corresponding to the respective historical noise reference signals may include:
transmitting, for each of the historical noise reference signals, the first reference excitation signal corresponding to the historical noise reference signal to the in-vehicle sound player, such that the in-vehicle sound player plays a first reference sound signal corresponding to the first reference excitation signal; and acquiring, based on the sound sensor at the target location, the error sound signal at the target position between the noise source outside the vehicle and the first reference sound signal.

For the historical noise reference signal at each time, the first reference excitation signal corresponding to the historical noise reference signal can be transmitted o the in-vehicle sound player at that time, such that the first reference sound signal played by the in-vehicle sound player and the out-of-vehicle noise corresponding to the historical noise reference signal are superimposed at the target location to generate an error noise, and the error sound signal at that time is acquired through the sound sensor at the target location. Based on the above process, the error sound signal at each time can be acquired.

In some alternative embodiments, the sound sensor at the target location acts as an error sound sensor, and an existing sound sensor of the vehicle may be reused as the error sound sensor. If there is no the sound sensor provided at the target location, a corresponding error sound sensor may also be temporarily provided at the target location for acquiring the error sound signal when predetermining fixed filter information, and the error sound sensor may be removed after obtaining an optimal filter coefficient of the fixed filter.

In this embodiment, an accurate and effective error sound signal can be provided for the optimization of the filter information by collecting the real error sound signal via the sound sensor at the target location.

In some alternative embodiments, the control information includes filter coefficients of a filter corresponding to the first noise reference signal; the step 2210 of determining, based on the first noise reference signal and the control information, a first excitation signal corresponding to an in-vehicle sound player may include: determining a historical noise reference signal prior to the first noise reference signal; and performing filtering processing on, based on the filter coefficient of the filter corresponding to the first noise reference signal, the first noise reference signal and the historical noise reference signal to obtain the first excitation signal.

The filter coefficient of the filter is equivalent to a weight, and is used for weighting the first noise reference signal and the historical noise reference signal to obtain the first excitation signal.

Illustratively, the first noise reference signal is a noise reference signal at time n, which is expressed as follows:

$$x ( n ) = {[ {x}_{m i c}^{1} ( n ) , {x}_{m i c}^{2} ( n ) , … , {x}_{m i c}^{M} ( n ) , {x}_{a v a s} ( n ) , {x}_{e n c}^{1} ( n ) , {x}_{e n c}^{2} ( n ) , … , {x}_{e n c}^{K} ( n ) ]}^{T}$$

the filtering process may be expressed as follows:

$$y ( n ) = {\sum }_{i = 1}^{{L}_{w}} {{w}_{i} ( n )}^{T} x ( n - i )$$

$$x ( n - i ) = {[ {x}_{m i c}^{1} ( n - i ) , {x}_{m i c}^{2} ( n - i ) , … , {x}_{m i c}^{M} ( n - i ) , \\ {x}_{a v a s} ( n - i ) , {x}_{e n c}^{1} ( n - i ) , {x}_{e n c}^{2} ( n - i ) , … , {x}_{e n c}^{K} ( n - i ) ]}^{T}$$

where y(n) represents a first excitation signal at time n, and x(n−1) to x(n−L_{W}) represent historical noise reference signals at various historical times. That is, x(n−i) represents the historical noise reference signal at time n−i, i=1, 2, . . . , L_{w}.

In some alternative embodiments, if the number of in-vehicle sound players is J, and the number of error sound sensors is D, the filtering process may be expressed as follows:

$${y}_{j} ( n ) = {\sum }_{i = 1}^{{L}_{w}} {{w}_{i j} ( n )}^{T} x ( n - i )$$

yⱼ(n) represents a first excitation signal corresponding to a j^{th} in-vehicle sound player. Reference can be made to the forgoing for additional symbols.

In this embodiment, the first excitation signal is obtained by combining the first noise reference signal at the current time and the historical noise reference signal, and the noise reference signal at a plurality of times can be referred to, which helps to improve the accuracy and effectiveness of the first excitation signal.

In some alternative embodiments, FIG. 6 is a schematic diagram showing an action principle of a first excitation signal according to an example embodiment of the present disclosure. As shown in FIG. 6, the out-of-vehicle noise source serves as a primary sound source, and the secondary sound source is an in-vehicle sound player. The noise generated by the out-of-vehicle noise source is transmitted to the in-vehicle target location via a primary path, which is a sound signal transmission path from the AVAS speaker to the in-vehicle target location. The in-vehicle original noise signal represents a noise signal which is formed by the first sound signal transmitted to the target location, the waveform diagram corresponding to the in-vehicle original noise signal in the figure represents the noise signal schematic diagram formed by the continuous first sound signal at the target location, and the noise signal of the first sound signal at the target location at a time corresponds to a value of a point on the waveform in the waveform diagram. The first noise reference signal corresponding to the out-of-vehicle noise source is performed filter processing by the filter to obtain the first excitation signal of the secondary sound source. The secondary path is a sound signal transmission path from the secondary sound source to the target location. The secondary sound source plays a sound signal (which may be referred to as a first sound signal) corresponding to the first excitation signal, and the first sound signal is transmitted to the target location via the secondary path. The reverse control signal represents the signal which is formed by the first sound signal transmitted to the target location. The waveform diagram corresponding to the reverse control signal in the figure shows a schematic representation of the control signal formed by successive first sound signals at the target location. This signal is reverse to the in-vehicle original noise signal generated at the target location by the sound signal of the out-of-vehicle noise source. The waveform diagrams in the figures are used to more clearly show the inversion of the noise signal and the control signal at the target location, as well as the actual noise signal after the superposition of the two. The in-vehicle original noise signal and the reverse control signal are superimposed at the target location, so that the reverse control signal counteracts the in-vehicle original noise signal since the two are reversed, thereby the noise at the target location becoming the signal shown by the in-vehicle actual noise in the figure, and it can be seen that the sound pressure level of the original noise at the target location of the sound signal of the out-of-vehicle noise source is effectively reduced.

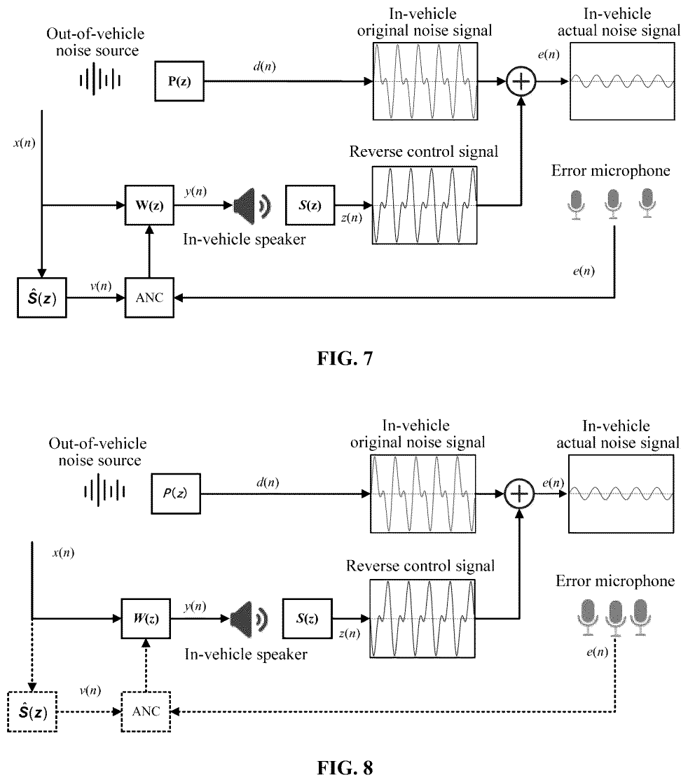

FIG. 7 is a schematic diagram showing an in-vehicle noise control principle based on an on-line adaptive filter according to an example embodiment of the present disclosure. As shown in FIG. 7, the secondary sound source is an in-vehicle speaker (i.e., an in-vehicle sound player), W(z) represents a filter, z in the W(z) represents a z transformation, and n is a time index, which can represent time n (or referred to as an n^{th} time frame), x(n) represents a first noise reference signal at time n, y(n) represents a first excitation signal at time n, P(z) represents a primary path, and d(n) represents the in-vehicle original noise signal at the time n formed by a sound signal of the out-of-vehicle noise source transmitted to the target location via the primary path, and S(z) represents an actual secondary path; z(n) represents a signal (may be referred to as a control signal, a reverse control signal) at which a first sound signal played by an in-vehicle speaker at time n is transmitted to the target location, and e(n) represents an error sound signal at time n. An error microphone is a sound sensor at the target location for collecting an error sound signal at the target location. Ŝ(z) represents a modeled secondary path (i.e., a secondary path transfer function), and v(n) represents a filtered reference signal at time n obtained based on a first noise reference signal at time n and the secondary path transfer function. Active Noise Control (ANC) represents an active noise control algorithm for updating the filter coefficients. ANC can update the filter coefficient W(n)P of W(z) at time n according to v(n) and e(n) to obtain the filter coefficient W(n+1) at time n+1 for generating the first excitation function at time n+1. Similarly, W(n) used to generate y(n) is obtained by updating W(n−1) based on v(n−1) and e(n−1) at time n−1. Based on this, the adaptive filter is implemented for generating the first excitation signal of the in-vehicle speaker corresponding to the first noise reference signal, so as to effectively control the external noise transmitted into the in-vehicle target location, and reduce the sound pressure level of the noise at the target location.

FIG. 8 is a schematic diagram showing an optimization principle of a fixed filter according to an example embodiment of the present disclosure. As shown in FIG. 8, the dashed portion represents an off-line optimization of a filter W(z). x(n) may represent the historical noise reference signal at time n, y(n) may represent the first reference excitation signal, and d(n) represents the in-vehicle original noise signal at time n formed by the sound signal of the out-of-vehicle noise source transmitted via the primary path to the target location. v(n) represents a filtered reference signal at time n obtained based on the historical noise reference signal at time n and a secondary path transfer function, z(n) represents a control signal transmitted to the target location by a sound signal played by the in-vehicle speaker at time n, and e(n) represents an error sound signal at the target location at time n between an out-of-vehicle noise source noise and y(n). Reference can be made to FIG. 7 for other symbols. ANC optimizes the filter coefficients based on v(n) and e(n), uses active noise control algorithm to solve the filter coefficients that minimize the objective function based on the historical noise reference signal at each time, and stores them as the filter coefficients of the fixed filter corresponding to the target location. The objective function may be constructed based on an expected minimization of the error sound signal at each time. It can be seen that the principle of the off-line optimization of the fixed filter is similar to the principle of the on-line adaptive optimization described above, and will not be described in detail herein.

For the adaptive filter as shown in FIG. 7 and the fixed filter as shown in FIG. 8, the degree to which the noise signal can be counteracted at the target location is determined by the optimal performance of the filter.

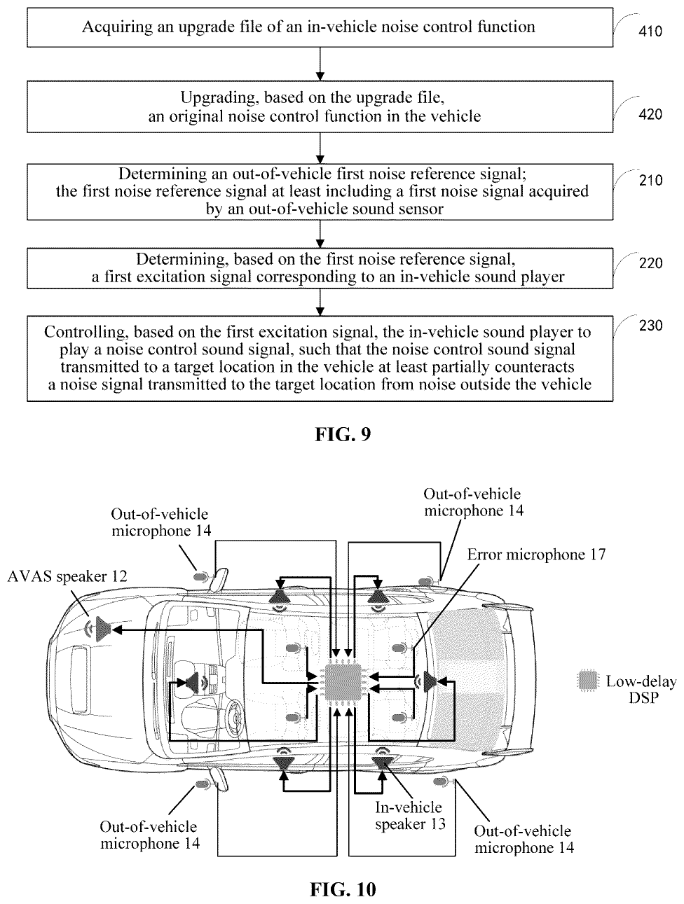

FIG. 9 is a schematic flow diagram showing a method for controlling in-vehicle noise according to still another example embodiment of the present disclosure.

In some alternative embodiments, based on any one of the embodiments described above, as shown in FIG. 9, the method in the embodiment of the present disclosure may further include:
step 410, acquiring an upgrade file of an noise control function in the vehicle.

The upgrade file of the in-vehicle noise control function may be downloaded from a device (e.g., a server) providing the upgrade file, or in a case where the upgrade file of the in-vehicle noise control function has been downloaded, and the upgrade file may be read from a storage space in which the upgrade file is stored. For example, the upgrade file of the in-vehicle noise control function is downloaded by an Over-the-Air Technology (OTA), the upgrade file is stored in a specified storage space on the vehicle, and when the function is upgraded, the upgrade file is read from the specified storage space to perform the upgrade.

Step 420, upgrading, based on the upgrade file, an original noise control function in the vehicle.

After the upgrade file is downloaded and obtained, the original noise control function in the vehicle can be upgraded via the upgrade file, such that the upgraded noise control function can implement the method of any one of the above-mentioned embodiments of the present disclosure.

The embodiments of the present disclosure can achieve the in-vehicle noise control function of the embodiments of the present disclosure by the OTA technology upgrade on a vehicle equipped with an out-of-vehicle sound sensor, improve the performance of the in-vehicle noise control algorithm without increasing the hardware cost, and effectively improve driving experience of a user.

In some alternative embodiments, FIG. 10 is a schematic structural diagram showing a control system for in-vehicle noise according to an example embodiment of the present disclosure. As shown in FIG. 10, an error microphone (i.e., an error sound sensor) 17 is provided at a predetermined location corresponding to each seat in the vehicle (a location close to the head or ears of the user, which may serve as a target location) for acquiring an error sound signal. An AVAS speaker 12 is provided at the out-of-vehicle front end, and six in-vehicle speakers 13 are provided in the vehicle. The AVAS speaker 12, each in-vehicle speaker 13 and each error microphone 17 are all connected to a low-delay Digital Signal Processing (DSP) chip, and the apparatus of the present disclosure is provided in the DSP chip, and the low-delay DSP chip ensures that the signal processing process has a low time delay. During vehicle traveling, if it is detected that the vehicle is traveling at a low speed and an audible alert needs to be played via the AVAS speaker 12, the DSP chip can generate a second excitation signal of the AVAS speaker 13 and play the audible alert via the AVAS speaker, and can acquire a acquired out-of-vehicle first noise signal from each out-of-vehicle microphone 14, and can also acquire engine speed information via a CAN bus, calculate a second noise signal of each harmonic, and determine a first noise reference signal based on the first noise signal, the second excitation signal and the second noise signal, determine filter information corresponding to a target location, and perform filtering processing on a first noise reference signal based on the filter information to obtain a first excitation signal, where the first excitation signal may include excitation signals respectively corresponding to each in-vehicle speaker 13 which is controlled to play a corresponding noise control sound signal via the first excitation signal. Each out-of-vehicle noise signal is transmitted to a preset location via a primary path with the target location, and a sound signal played by the in-vehicle speaker 13 is transmitted to the preset location via a secondary path, and is superimposed with the noise signal at the preset location to counteract all or part of the noise signal transmitted to the preset location, such that the sound pressure level of the noise at the preset location in the vehicle can be reduced, and thus driving experience of a user of a user corresponding to the preset location can be improved. Each error microphone 17 acquires the counteracted error sound signal at the preset location for updating the filter. Using low-delay DSP can reduce the delay of signal processing and improve the real time of signal processing.

The method for controlling noise in a vehicle of the embodiments of the present disclosure can effectively reduce the sound pressure level of the in-vehicle noise in a static or low-speed scene without increasing the hardware cost by multiplexing the out-of-vehicle voice interactive microphones. Since an out-of-vehicle microphone can acquire the actual sound signal of the out-of-vehicle speaker as a noise reference signal, it can be combined with the AVAS noise reduction algorithm to further enhance the performance of the AVAS noise reduction algorithm. Since the acquired noise reference signal can further include the real noise signal generated by the engine, in addition to controlling the harmonic signal of the engine, it can also control the noise (such as broadband noise) generated by the engine in addition to the harmonic signal, so it can be combined with the engine noise control (ENC) algorithm to further improve the algorithm performance of the ENC in static or low-speed scenes. In addition, on a vehicle model equipped with an out-of-vehicle microphone, upgrades can be made by the OTA technology, such that the vehicle can obtain the in-vehicle noise control function of the embodiments of the disclosure.

The above-mentioned embodiments of the present disclosure may be implemented alone or in any combination without conflict, and specifically may be set as needed, to which the present disclosure is not limited.

Any of the methods for controlling noise in a vehicle provided by the embodiments of the present disclosure may be performed by any suitable device having data processing capabilities, including, but not limited to: a terminal device and a server, etc. Alternatively, any of the method for controlling in-vehicle noises provided by the embodiments of the present disclosure may be executed by a processor, such as the processor executing any of the method for controlling in-vehicle noises mentioned by the embodiments of the present disclosure by calling corresponding instructions stored in a memory. It is not described hereafter in detail.

### Examples of Apparatus

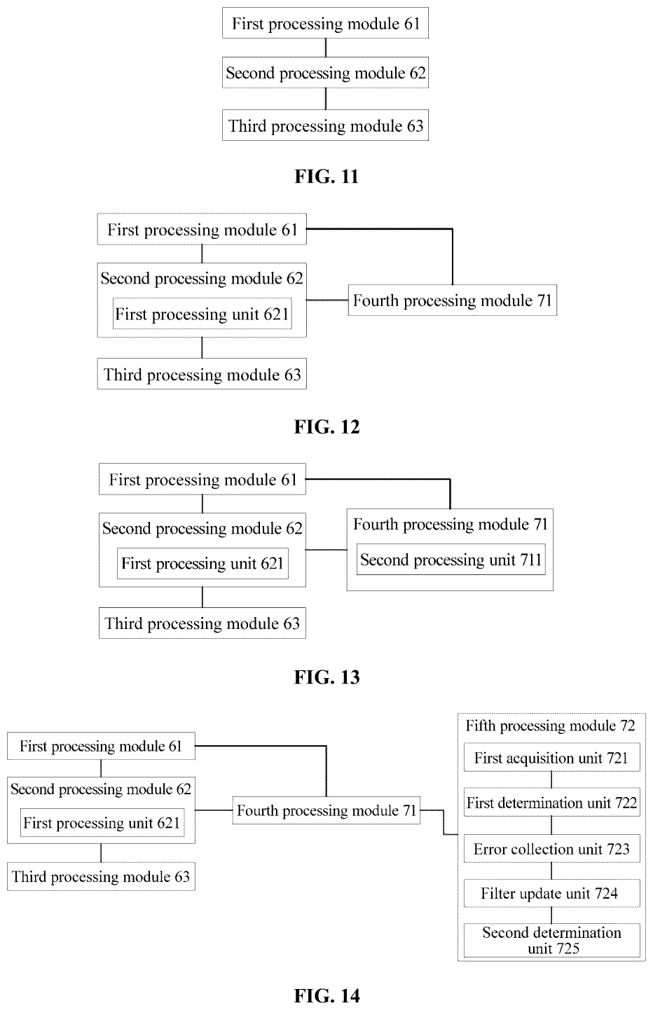

FIG. 11 is a schematic structural diagram showing an apparatus for controlling in-vehicle noise according to an example embodiment of the present disclosure. The apparatus of this embodiment can be used to implement a corresponding method embodiment of the present disclosure, and the apparatus as shown in FIG. 11 may include: a first processing module 61, a second processing module 62 and a third processing module 63.

The first processing module 61 is configured for determining a first noise reference signal outside the vehicle, the first noise reference signal comprising a first noise signal acquired by an external sound sensor for the vehicle.

In some alternative embodiments, the first processing module 61 may include an interface to a device that provides a first noise reference signal or a processing unit connected to the interface. For example, the first processing module 61 may include an interface to an out-of-vehicle sound sensor for receiving a first noise signal transmitted by the out-of-vehicle sound sensor. The first processing module 61 may further include an interface connected to a vehicle bus for obtaining engine speed information from the vehicle bus and for determining a second noise signal based on the engine speed information. The first processing module 61 may further include an interface to a device or component for generating a second excitation signal for an out-of-vehicle sound player for acquiring the second excitation signal. The first processing module 61 may further include processing circuitry for forming the signals received by each interface into the first noise reference signal.

The second processing module 62 is configured for determining, based on the first noise reference signal, a first excitation signal corresponding to an in-vehicle sound player.

In some alternative embodiments, the second processing module 62 may be a filtering circuit or other processing unit having a filtering function for performing signal conversion by filtering the first noise reference signal to obtain a first excitation signal corresponding to the in-vehicle sound player.

The third processing module 63 is configured for controlling, based on the first excitation signal, the in-vehicle sound player to play a noise control sound signal, such that the noise control sound signal transmitted to a target location in the vehicle at least partially counteracts a noise signal transmitted to the target location from noise outside the vehicle.

In some alternative embodiments, the third processing module 63 may be an output interface connected to the in-vehicle sound player for outputting the first excitation signal to the in-vehicle sound player to cause the in-vehicle sound player to convert the first excitation signal to a noise control sound signal for playback.

In some alternative embodiments, the first noise reference signal may further include at least one of:
a second excitation signal for controlling an out-of-vehicle sound player to play a sound signal and a second noise signal generated by an engine.

FIG. 12 is a schematic structural diagram showing an apparatus for controlling noise in a vehicle according to another example embodiment of the present disclosure.

As shown in FIG. 12, the apparatus in the embodiment of the present disclosure may further include:
a fourth processing module 71 configured for, determining control information corresponding to the first noise reference signal.

In some alternative embodiments, the fourth processing module 71 may be a read-write access controller for reading prestored control information from a specified memory space.

In some alternative embodiments, the fourth processing module 71 may be a processor with a filter update function for obtaining real time control information.

The second processing module 62 may include: a first processing unit 621 configured for determining, based on the first noise reference signal and the control information, a first excitation signal corresponding to an in-vehicle sound player.

FIG. 13 is a schematic configuration diagram showing an apparatus for controlling noise in a vehicle according to yet another example embodiment of the present disclosure.

In some alternative embodiments, as shown in FIG. 13, in a case where the control information includes filter information, the fourth processing module 71 may include:
a second processing unit 711 configured for determining the filter information corresponding to the target location.

In some alternative embodiments, the first noise reference signal is a noise reference signal at a current time; the second processing unit 711 may be specifically configured for determining the filter information corresponding to the target location at the current time based on a historical noise reference signal at a historical time prior to the current time, historical filter information at a previous time corresponding to the target location, and a historical error sound signal acquired by a sound sensor at the target location at the previous time.

In some alternative embodiments, the second processing unit 711 may be specifically configured for determining a historical filtered reference signal based on the historical noise reference signal, a secondary path transfer function between the in-vehicle sound player and the target location; and updating, based on the historical filtered reference signal and the historical error sound signal, the historical filter information to obtain the filter information corresponding to the target location at the current time.

In some alternative embodiments, in a case where the control information includes filter information, the second processing unit 711 may be specifically configured for: acquiring fixed filter information corresponding to the target location obtained in advance.

FIG. 14 is a schematic structural diagram showing an apparatus for controlling noise in a vehicle according to still another example embodiment of the present disclosure.

In some alternative embodiments, the fixed filter information includes the filter coefficients of the fixed filter. As shown in FIG. 14, the apparatus of an embodiment of the present disclosure may further include: a fifth processing module 72 for acquiring fixed filter information. The fifth processing module 72 may include: a first acquisition unit 721, a first determination unit 722, an error collecting unit 723, a filter update unit 724, and a second determination unit 725.

The first acquisition unit 721 is configured for acquiring the historical noise reference signal at at least one time outside the vehicle.

The first determination unit 722 is configured for determining, based on the respective historical noise reference signals and the filter coefficient to be updated, a first reference excitation signal of the in-vehicle sound player respectively corresponding to the respective historical noise reference signals.

The error collecting unit 723 is configured for acquiring, based on the respective historical noise reference signals and the first reference excitation signal respectively corresponding to the respective historical noise reference signals, an error sound signal at the target location respectively corresponding to the respective historical noise reference signals.

The filter update unit 724 is configured for updating the filter coefficient based on the respective historical noise reference signals and the error sound signal respectively corresponding to the respective historical noise reference signals, to obtain the updated filter coefficient corresponding to the fixed filter.

The second determination unit 725 is configured for determining, based on the updated filter coefficient, the fixed filter information.

In some alternative embodiments, the error collecting unit 723 may be specifically configured for:
transmitting, for each of the historical noise reference signals, the first reference excitation signal corresponding to the historical noise reference signal to the in-vehicle sound player, such that the in-vehicle sound player plays a first reference sound signal corresponding to the first reference excitation signal; and collecting, based on the sound sensor at the target location, the noise outside the vehicle and the error sound signal of the first reference sound signal at the target location.

In some alternative embodiments, the control information includes filter coefficients of a filter corresponding to the first noise reference signal; the first processing unit 621 can be specifically configured for determining a historical noise reference signal prior to the first noise reference signal; and performing filtering processing on, based on the filter coefficient of the filter corresponding to the first noise reference signal, the first noise reference signal and the historical noise reference signal to obtain the first excitation signal.

Each of the modules and units in the above-described embodiments may be a circuit module or unit having a corresponding function in a signal processing chip, for example, a low-delay DSP chip.

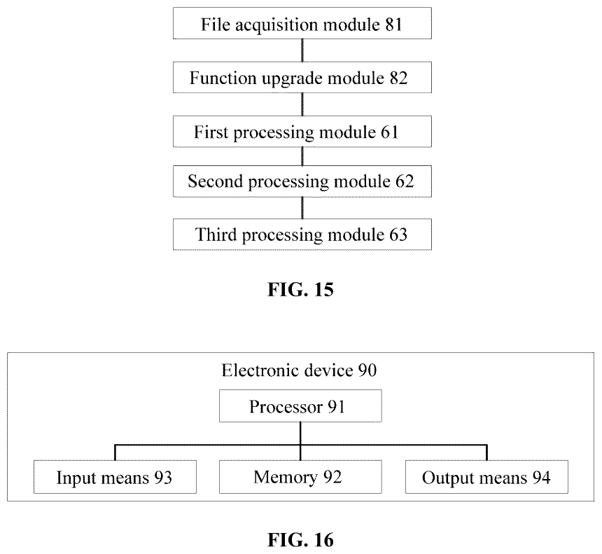

FIG. 15 is a schematic configuration diagram showing an apparatus for controlling noise in a vehicle according to yet another example embodiment of the present disclosure.

In some alternative embodiments, based on any one of the embodiments described above, as shown in FIG. 15, the apparatus in the embodiment of the present disclosure may further include:
a file acquisition module 81 configured for acquiring an upgrade file of an noise control function in the vehicle; and
a function upgrade module 82 configured for upgrading, based on the upgrade file, an original noise control function in the vehicle.
the file acquisition module 81 and the function upgrading module 82 can be a processor having an upgrading function.

It should also be noted that in the apparatus, devices and methods of the present disclosure, the components or steps may be decomposed and/or recombined. Such decomposition and/or recombination should be considered as equivalents of the present disclosure.

Advantageous technical effects corresponding to example embodiments of the apparatus may be seen in the respective advantageous technical effects of the above section described above and will not be described in detail here.

### Examples of Electronic Device

FIG. 16 is a structural diagram showing an electronic device including at least one processor 91 and memory 92 provided by an embodiment of the present disclosure.

The processor 91 may be a central processing unit (CPU) or other form of processing unit having data processing capabilities and/or instruction execution capabilities, and may control other components in the electronic device 90 to execute expected functions.

The memory 92 may include one or more computer program products, which may include various forms of computer-readable storage media, such as volatile memory and/or non-volatile memory. The volatile memory may for example include a random-access memory (RAM) and/or a cache memory (cache) etc. The non-volatile memory may include, for example, a read only memory (ROM), a hard disk, a flash memory, etc. One or more computer program instructions may be stored on a computer-readable storage medium, and the processor 91 may execute one or more computer program instructions to perform the methods and/or other expected functions of the various embodiments of the present disclosure above.

In one example, the electronic device 90 may further include: input means 93 and output means 94, which are interconnected by a bus system and/or other form of connection mechanism (not shown).

The input means 93 may further include, for example, a keyboard, a mouse, a touch screen, a sound pick-up device, etc.

The output means 94 may output various information to the outside, which may include, for example, a display, a speaker, a printer, and a communication network and its connected remote output devices, etc.

Of course, for simplicity, only some of the components of the electronic device 90 relevant to the present disclosure are shown in FIG. 16, omitting components such as buses, input/output interfaces, etc. In addition, the electronic device 90 may include any other suitable components depending on the particular application.

### Example of Computer Program Product and Computer-readable Storage Medium

In addition to the methods and devices described above, embodiments of the present disclosure may also provide a computer program product including computer program instructions which, when executed by a processor, cause the processor to perform the steps in the methods of various embodiments of the present disclosure described in the “Example Methods” section above.

The computer program product may have program code for performing operations of embodiments of the present disclosure written in any combination of one or more programming languages, including object-oriented programming languages, such as Java, C++, etc. and further including conventional procedural programming languages, such as the “C” language or similar programming languages. The program code may execute entirely on the user computing device, partially on the user device, as a stand-alone software package, partially on the user computing device, partially on a remote computing device, or entirely on the remote computing device or server.

Furthermore, embodiments of the present disclosure may also be a computer-readable storage medium having stored thereon computer program instructions which, when executed by a processor, cause the processor to perform the steps in the methods of the various embodiments of the present disclosure described in the “example Methods” section above.

The computer-readable storage medium may take any combination of one or more readable media. The readable medium may be a readable signal medium or a readable storage medium. The readable storage medium for example but not limited to, an electronic, magnetic, optical, electromagnetic, infrared, or semiconductor system, apparatus, or component, or a combination of any one of the foregoing. More specific examples (a non-exhaustive list) of the readable storage medium include: an electrical connection having one or more wires, a portable computer diskette, a hard disk, a Random-access Memory (RAM), a read-only memory (ROM), an Erasable Programmable Read-only Memory (EPROM or flash memory), an optical fiber, a portable Compact Disk Read-only Memory (CD-ROM), an optical storage component, a magnetic storage component, or any suitable combination thereof.

The general principles of the present disclosure have been described above in connection with specific embodiments, the advantages, advantages, effects, etc. set forth in the present disclosure are merely example and not limiting, and are not to be construed as necessarily referring to the various embodiments of the present disclosure. Furthermore, the particular details disclosed above are for purposes of illustration and description only and are not intended to be limiting, as the present disclosure is not limited to the particular details disclosed above.

Various modifications and alterations to the present disclosure will become apparent to a person skilled in the art without departing from the spirit and scope of the present application. Thus, in case the modifications and variations of the present application are fallen into the scope of the claims and their equivalents, it is intended that the modifications and variations are included in the present disclosure.

What is claimed is:

1. A method for controlling noise in a vehicle, comprising:
determining a first noise reference signal outside the vehicle, the first noise reference signal comprising a first noise signal acquired by an external sound sensor for the vehicle;
determining, based on the first noise reference signal, a first excitation signal corresponding to an in-vehicle sound player; and
controlling, based on the first excitation signal, the in-vehicle sound player to play a noise control sound signal, such that the noise control sound signal transmitted to a target location in the vehicle at least partially counteracts a noise signal transmitted to the target location from noise outside the vehicle.

2. The method according to claim 1, wherein the first noise reference signal further comprises at least one of:
a second excitation signal for controlling an out-of-vehicle sound player to play a sound signal and a second noise signal generated by an engine.

3. The method according to claim 1, further comprising:
determining control information corresponding to the first noise reference signal;
wherein the determining, based on the first noise reference signal, a first excitation signal corresponding to an in-vehicle sound player comprises:
determining, based on the first noise reference signal and the control information, the first excitation signal corresponding to the in-vehicle sound player.

4. The method according to claim 3, wherein the control information comprises filter information; and the determining control information corresponding to the first noise reference signal comprises:
determining the filter information corresponding to the target location.

5. The method according to claim 4, wherein the first noise reference signal is a noise reference signal at a current time;
the determining the filter information corresponding to the target location comprises:
determining the filter information corresponding to the target location at the current time based on a historical noise reference signal at a historical time prior to the current time, historical filter information at a previous time corresponding to the target location, and a historical error sound signal acquired by a sound sensor at the target location at the previous time.

6. The method according to claim 5, wherein the determining the filter information corresponding to the target location at the current time based on a historical noise reference signal at a historical time prior to the current time, historical filter information at a previous time corresponding to the target location, and a historical error sound signal acquired by a sound sensor at the target location at the previous time comprises:
determining a historical filtered reference signal based on the historical noise reference signal, a secondary path transfer function between the in-vehicle sound player and the target location; and
updating, based on the historical filtered reference signal and the historical error sound signal, the historical filter information to obtain the filter information corresponding to the target location at the current time.

7. The method according to claim 4, wherein the determining the filter information corresponding to the target location comprises:
obtaining fixed filter information corresponding to the target location obtained in advance.

8. The method according to claim 7, wherein the fixed filter information comprises a filter coefficient of a fixed filter; and the fixed filter information is obtained by:
acquiring the historical noise reference signal at at least one time outside the vehicle;
determining, based on the respective historical noise reference signals and the filter coefficient to be updated, a first reference excitation signal of the in-vehicle sound player respectively corresponding to the respective historical noise reference signals;
acquiring, based on the respective historical noise reference signals and the first reference excitation signal respectively corresponding to the respective historical noise reference signals, an error sound signal at the target location respectively corresponding to the respective historical noise reference signals;
updating the filter coefficient to be updated based on the respective historical noise reference signals and the error sound signal respectively corresponding to the respective historical noise reference signals, to obtain the updated filter coefficient corresponding to the fixed filter; and
determining, based on the updated filter coefficient, the fixed filter information.

9. The method according to claim 8, wherein the acquiring, based on the respective historical noise reference signals and the first reference excitation signal respectively corresponding to the respective historical noise reference signals, an error sound signal at the target location respectively corresponding to the respective historical noise reference signals comprises:
transmitting, for each of the historical noise reference signals, the first reference excitation signal corresponding to the historical noise reference signal to the in-vehicle sound player, such that the in-vehicle sound player plays a first reference sound signal corresponding to the first reference excitation signal; and
acquiring, based on the sound sensor at the target location, the noise outside the vehicle and the error sound signal of the first reference sound signal at the target location.

10. The method according to claim 3, wherein the control information comprises a filter coefficient of a filter corresponding to the first noise reference signal;
the determining, based on the first noise reference signal and the control information, the first excitation signal corresponding to the in-vehicle sound player comprises:
determining a historical noise reference signal prior to the first noise reference signal; and
performing filtering processing on, based on the filter coefficient of the filter corresponding to the first noise reference signal, the first noise reference signal and the historical noise reference signal to obtain the first excitation signal.

11. The method according to claim 1, further comprising:
obtaining an upgrade file of an noise control function in the vehicle; and
upgrading, based on the upgrade file, an original noise control function in the vehicle.

12. A computer-readable storage medium, storing a computer program thereon which, when executed by a processor, cause the processor to perform a method for controlling noise in a vehicle, comprising:
determining a first noise reference signal outside the vehicle, the first noise reference signal comprising a first noise signal acquired by an external sound sensor for the vehicle;
determining, based on the first noise reference signal, a first excitation signal corresponding to an in-vehicle sound player; and
controlling, based on the first excitation signal, the in-vehicle sound player to play a noise control sound signal, such that the noise control sound signal transmitted to a target location in the vehicle at least partially counteracts a noise signal transmitted to the target location from noise outside the vehicle.

13. An electronic device, comprising:
a processor;
a memory configured to store the processor-executable instruction;
wherein the processor is configured to read the executable instructions from the memory and execute the instructions to implement a method for controlling noise in a vehicle, comprising:
determining a first noise reference signal outside the vehicle, the first noise reference signal comprising a first noise signal acquired by an external sound sensor for the vehicle;
determining, based on the first noise reference signal, a first excitation signal corresponding to an in-vehicle sound player; and
controlling, based on the first excitation signal, the in-vehicle sound player to play a noise control sound signal, such that the noise control sound signal transmitted to a target location in the vehicle at least partially counteracts a noise signal transmitted to the target location from noise outside the vehicle.

14. The electronic device according to claim 13, further comprising:
determining control information corresponding to the first noise reference signal;
wherein the determining, based on the first noise reference signal, a first excitation signal corresponding to an in-vehicle sound player comprises:
determining, based on the first noise reference signal and the control information, the first excitation signal corresponding to the in-vehicle sound player.

15. The electronic device according to claim 14, wherein the control information comprises filter information; and the determining control information corresponding to the first noise reference signal comprises:
determining the filter information corresponding to the target location.

16. The electronic device according to claim 15, wherein the first noise reference signal is a noise reference signal at a current time;
the determining the filter information corresponding to the target location comprises:
determining the filter information corresponding to the target location at the current time based on a historical noise reference signal at a historical time prior to the current time, historical filter information at a previous time corresponding to the target location, and a historical error sound signal acquired by a sound sensor at the target location at the previous time.

17. The electronic device according to claim 16, wherein the determining the filter information corresponding to the target location at the current time based on a historical noise reference signal at a historical time prior to the current time, historical filter information at a previous time corresponding to the target location, and a historical error sound signal acquired by a sound sensor at the target location at the previous time comprises:
determining a historical filtered reference signal based on the historical noise reference signal, a secondary path transfer function between the in-vehicle sound player and the target location; and
updating, based on the historical filtered reference signal and the historical error sound signal, the historical filter information to obtain the filter information corresponding to the target location at the current time.

18. The electronic device according to claim 15, wherein the determining the filter information corresponding to the target location comprises:
obtaining fixed filter information corresponding to the target location obtained in advance.

19. The electronic device according to claim 18, wherein the fixed filter information comprises a filter coefficient of a fixed filter; and the fixed filter information is obtained by:
acquiring the historical noise reference signal at at least one time outside the vehicle;
determining, based on the respective historical noise reference signals and the filter coefficient to be updated, a first reference excitation signal of the in-vehicle sound player respectively corresponding to the respective historical noise reference signals;
acquiring, based on the respective historical noise reference signals and the first reference excitation signal respectively corresponding to the respective historical noise reference signals, an error sound signal at the target location respectively corresponding to the respective historical noise reference signals;
updating the filter coefficient based on the respective historical noise reference signals and the error sound signal respectively corresponding to the respective historical noise reference signals, to obtain the updated filter coefficient corresponding to the fixed filter; and
determining, based on the updated filter coefficient, the fixed filter information.

20. The electronic device according to claim 19, wherein the acquiring, based on the respective historical noise reference signals and the first reference excitation signal respectively corresponding to the respective historical noise reference signals, an error sound signal at the target location respectively corresponding to the respective historical noise reference signals comprises:
transmitting, for each of the historical noise reference signals, the first reference excitation signal corresponding to the historical noise reference signal to the in-vehicle sound player, such that the in-vehicle sound player plays a first reference sound signal corresponding to the first reference excitation signal; and
acquiring, based on the sound sensor at the target location, the noise outside the vehicle and the error sound signal of the first reference sound signal at the target location.
